(19) United States
(12) Patent Application Publication
(10) Pub. No.: US 2025/0217578 A1
(43) Pub. Date: Jul. 3, 2025

(54) INFORMATION PROCESSING SYSTEM, INFORMATION PROCESSING METHOD, AND NON-TRANSITORY COMPUTER READABLE MEDIUM STORING PROGRAM

(71) Applicant: RAKUTEN GROUP, INC., Tokyo (JP)

(72) Inventors: Diego MATEOS, Tokyo (JP); Luis Orellana, Tokyo (JP); Sudev Chirappat, Tokyo (JP); Takafumi Watanabe, Tokyo (JP); Siqi Li, Tokyo (JP); Soonhyung Kwon, Tokyo (JP); Chiachia Wu, Tokyo (JP)

(73) Assignee: RAKUTEN GROUP, INC., Tokyo (JP)

(21) Appl. No.: 18/767,531

(22) Filed: Jul. 9, 2024

(30) Foreign Application Priority Data
Dec. 28, 2023 (JP) 2023-222417

(51) Int. Cl. G06F 40/166

(52) U.S. Cl. CPC G06F 40/166

(57) ABSTRACT

An information processing method causes one or multiple computers to obtain an original text input by an administrator, obtain a guideline related to editing of the original text from a memory, transmit the original text and the guideline to one or multiple editing models to obtain one or multiple edited texts in which the original text is edited, and transmit the original text, one of the edited texts, and the guideline to an evaluation model to perform an evaluation to determine whether the one of the edited texts has been edited in accordance with the guideline.

### CROSS-REFERENCE TO RELATED APPLICATIONS

This application is based upon and claims the benefit of priority from prior Japanese Patent Application No. 2023-222417, filed on Dec. 28, 2023, the entire contents of which are incorporated herein by reference.

### BACKGROUND

### 1. Field

The present disclosure relates to an information processing system, an information processing method, and a non-transitory computer readable medium storing a program.

### 2. Description of Related Art

Japanese Laid-Open Patent Publication No. 2018-128805 discloses an information processing system for generating summaries. The summaries are used on product sales pages on an electronic commerce site. This information processing system is configured to obtain a summary, which is an edited text, by inputting a description of a product, which is an original text, into a learning model. On a typical electronic commerce site, an administrator of various products input descriptions for the products, which are transaction objects.

One of the objectives for a system operator editing these descriptions is to standardize the format of the descriptions, making it easier for users to compare multiple products. On the other hand, multiple administrators elaborate expressions of descriptions in order to communicate the attractiveness of various products handled by the administrators. As a result, the writing styles of the product descriptions can vary significantly.

Since the writing styles of the descriptions, which are original texts, vary significantly, the descriptions may not be edited as desired by the operator. Therefore, there is a desire to improve the accuracy of editing from original texts.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an information processing system includes one or multiple servers. At least one of the one or multiple servers is configured to obtain an original text input by an administrator. At least one of the one or multiple servers is configured to obtain a guideline related to editing of the original text from a memory. At least one of the one or multiple servers is configured to transmit the original text and the guideline to one or multiple editing models to obtain one or multiple edited texts in which the original text is edited in accordance with the guideline. At least one of the one or multiple servers is configured to transmit the original text, one of the edited texts, and the guideline to an evaluation model to perform an evaluation to determine whether the one of the edited texts has been edited in accordance with the guideline.

In another general aspect, an information processing method includes causing one or multiple computers to obtain an original text input by an administrator, obtain a guideline related to editing of the original text from a memory, transmit the original text and the guideline to one or multiple editing models to obtain one or multiple edited texts in which the original text is edited in accordance with the guideline, and transmit the original text, one of the edited texts, and the guideline to an evaluation model to perform an evaluation to determine whether the one of the edited texts has been edited in accordance with the guideline.

In yet another general aspect, a non-transitory computer readable medium stores a program for causing one or multiple computers to obtain an original text input by an administrator, obtain a guideline related to editing of the original text from a memory, transmit the original text and the guideline to one or multiple editing models to obtain one or multiple edited texts in which the original text is edited in accordance with the guideline, and transmit the original text, one of the edited texts, and the guideline to an evaluation model to perform an evaluation to determine whether the one of the edited texts has been edited in accordance with the guideline.

Other features and aspects will be apparent from the following detailed description, the drawings, and the claims.

### BRIEF DESCRIPTION OF THE DRAWINGS

FIG. 1 is a diagram illustrating an overall configuration of an information processing system according to a first embodiment.

FIG. 2 is a diagram illustrating an electrical configuration of a terminal device according to the first embodiment.

FIG. 3 is a diagram illustrating an electrical configuration of the information processing device according to the first embodiment.

FIG. 4 is a diagram illustrating control contents of the information processing system according to the first embodiment.

FIG. 5 is a diagram showing guidelines according to the first embodiment.

FIG. 6 is a diagram showing descriptions, summaries, and translated texts according to the first embodiment.

FIG. 7 is a diagram illustrating evaluation result information according to the first embodiment.

FIG. 8 is a flowchart showing a summarization controlling process according to the first embodiment.

FIG. 9 is a flowchart showing an evaluation controlling process according to the first embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

An information processing device, an information processing system, an information processing method, and a non-transitory computer readable medium that stores a program according to an embodiment will now be described.

### Configuration of Information Processing System 10

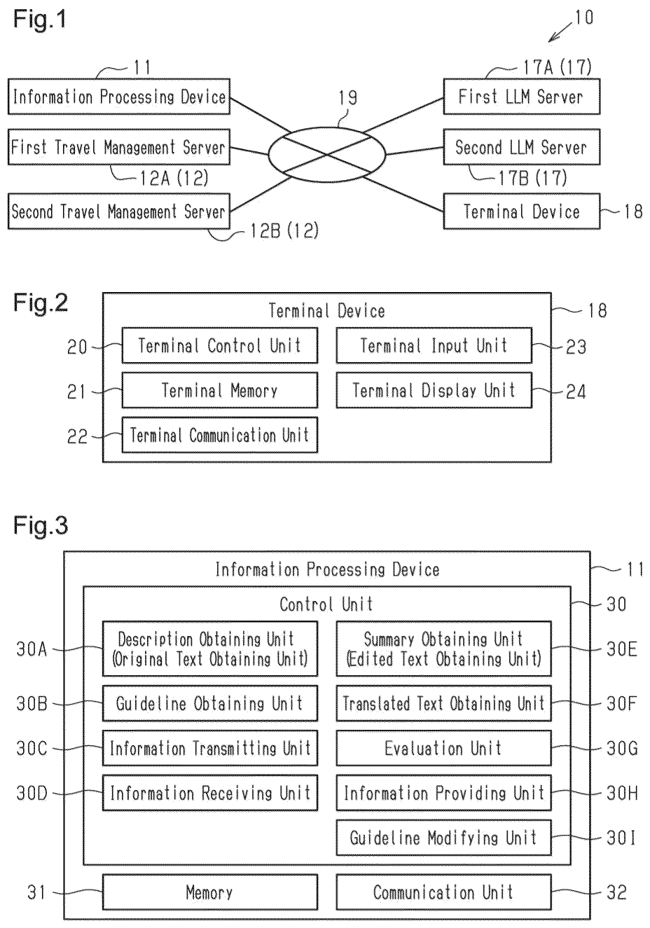

As shown in FIG. 1, an information processing system 10 is configured to provide information to users. The information processing system 10 performs control related to services provided to users.

The information processing system 10 includes an information processing device 11. The information processing device 11 performs control related to information to be provided to users. The information processing device 11 performs control related to services provided to users. The information processing device 11 is managed by an administrator of the information processing device 11. The information processing device 11 is managed by an operator of the information processing system 10.

The information processing system 10 may include one or multiple travel management servers 12. The travel management servers 12 are, for example, web servers that provide travel services to users. The travel management servers 12 are configured to manage information on travels so that users can view the information on travels through a website. The travel management servers 12 each manage information input by administrators of transaction objects. The administrators of the transaction objects are business operators who provide travel services. Information related to multiple products or multiple services provided from multiple business operators is posted on the website. The transaction objects include, for example, hotels, restaurants, and package tours, and transactions include reservations, purchases, sales, lending, and usage.

The travel management servers 12 may include a first travel management server 12A. The first travel management server 12A is configured to manage information related to at least travel in a first country. The first travel management server 12A is configured to manage information on travel written in a first language. For example, the first country may be Japan, and the first language may be Japanese.

The travel management servers 12 may include a second travel management server 12B. The second travel management server 12B may be configured to manage information related to travel in a second country. The second travel management server 12B may be configured to manage information related to travel in the first country. The second travel management server 12B is configured to manage information on travel written in a second language. For example, the second country may be the United States of America and the second language may be English.

The information processing system 10 may include one or multiple large language model (LLM) servers 17. Hereinafter, the large language model servers 17 will be referred to as LLM servers 17. The LLM servers 17 may include a first LLM server 17A and a second LLM server 17B.

The LLM servers 17 each include a large language model. A large language model is a natural language processing model constructed by a large amount of data and a deep learning technique. The LLM servers 17 use a generative artificial intelligence to perform various types of processes for handling natural languages that are used by humans on a daily basis. The LLM servers 17 include various types of learning models of a generative artificial intelligence.

For example, the LLM servers 17 each include a summarization model using a generative artificial intelligence to summarizing input texts. The summarization model is a learning model related to summarization of texts. Summarizing an original text is included in editing of the original text. The summarization model is an example of an editing model. The editing model is a learning model related to editing of original texts.

The first LLM server 17A may have a first summarization model, and the second LLM server 17B may have a second summarization model. The first summarization model and the second summarization model may be learning models having different algorithms or parameters. In this case, the first summarization model generates a first summary, and the second summarization model generates a second summary. The first summary and the second summary may be different from each other even if the original text before editing is the same.

The LLM servers 17 each include a translation model using a generative artificial intelligence to translate an input text into a specified language. The translation model is a learning model related to translation of texts. Translating an original text is included in editing of the original text. The translation model is an example of an editing model. The translation model is a learning model related to editing of original texts.

The first LLM server 17A may include a first translation model and the second LLM server 17B may include a second translation model. The first translation model and the second translation model may be learning models having different algorithms or parameters. In this case, the first translation model generates first translated text and the second translation model generates second translated text. The first translated text and the second translated text may be different from each other even if the original text before editing is the same.

The LLM servers 17 each include an evaluation model using a generative artificial intelligence, and each evaluate multiple input texts by comparing the texts. The evaluation model is a learning model that compares input texts (for example, an original text and an edited text) to evaluate the input texts (particularly, edited texts).

The first LLM server 17A may have a first evaluation model, and the second LLM server 17B may include a second evaluation model. The first evaluation model and the second evaluation model may be learning models having different algorithms or parameters. In this case, the first evaluation model outputs a first evaluation result, and the second evaluation model outputs a second evaluation result. The first evaluation result and the second evaluation result may be different from each other even if the evaluation target is the same.

The information processing system 10 may include one or multiple terminal devices 18. The terminal devices 18 may be user terminal devices used by users. The user terminal devices may be mobile terminal devices. A ‘user’ refers to an individual who uses the website and is a prospective transactor of a transaction object.

The information processing device 11, the one or multiple travel management servers 12, the one or multiple LLM servers 17, and the one or multiple terminal devices 18 may communicate with each other via a network 19. At least any combination of the information processing device 11, the one or multiple travel management servers 12, the one or multiple LLM servers 17, and the one or multiple terminal devices 18 may be communicably connected directly without the network 19. Hereinafter, description of communication between multiple devices via the network 19 will be omitted.

### Configuration of Terminal Devices 18

As illustrated in FIG. 2, each terminal device 18 may be implemented by one or multiple computers. The terminal device 18 includes a terminal control unit 20, a terminal memory 21, a terminal communication unit 22, a terminal input unit 23, and a terminal display unit 24.

The terminal control unit 20 is configured to control the terminal device 18. The terminal control unit 20 includes an arithmetic device and a main storage medium. The arithmetic device loads an operating system (OS) and programs from the terminal memory 21 into the main storage medium and executes instructions retrieved from the main storage medium. The arithmetic device is circuitry. The circuitry may be a central processing unit (CPU), a graphic processing unit (GPU), or a neural network processing unit (NPU). The terminal memory 21 is an auxiliary storage medium and may store programs. The programs may include a dedicated application for using the information processing system 10.

The terminal communication unit 22 is implemented as hardware, software, or a combination of these. The terminal communication unit 22 transmits and receives data to and from the information processing device 11. The terminal input unit 23 is configured to input information in response to operation by the user. The terminal input unit 23 may be a touch screen integrated with the terminal display unit 24. The terminal input unit 23 may be a pointing device of an operation button. The terminal display unit 24 displays information in response to an output instruction from the terminal control unit 20.

### Configuration of Information Processing Device 11

As illustrated in FIG. 3, the information processing device 11 may be implemented by one or multiple computers. The information processing device 11 includes a control unit 30, a memory 31, and a communication unit 32. The control unit 30 may be a processor that controls the information processing device 11. The control unit 30 includes an arithmetic device and a main storage medium. The control unit 30 has the same configuration as the terminal control unit 20, and the description of the arithmetic device and the main storage medium will be omitted. The arithmetic device may be implemented as hardware, software, or a combination of these. The memory 31 is an auxiliary storage medium and is a non-transitory computer readable medium that stores information for managing the information processing device 11.

The communication unit 32 is implemented as hardware, software, or a combination of these. The communication unit 32 transmits and receives data to and from the one or multiple travel management servers 12 and the one or multiple LLM servers 17. The information processing device 11 may include an operation unit operated by an information provider when inputting information, or may include a display unit that displays information.

The travel management servers 12 and the LLM servers 17 are configured in the same manner as the information processing device 11. That is, the travel management servers 12 and the LLM servers 17 have the same configurations as the control unit 30, the memory 31, and the communication unit 32 in the information processing device 11. The configurations of the travel management servers 12 and the LLM servers 17 will be omitted.

### Information Processing Device 11

In the information processing device 11, the control unit 30 may be implemented by processing circuitry that executes programs. The control unit 30 includes a description obtaining unit 30A, a guideline obtaining unit 30B, an information transmitting unit 30C, and an information receiving unit 30D. The control unit 30 includes a summary obtaining unit 30E, a translated text obtaining unit 30F, an evaluation unit 30G, an information providing unit 30H, and a guideline modifying unit 30I.

The description obtaining unit 30A obtains multiple descriptions written for respective transaction objects. Hereinafter, descriptions of transaction objects will simply be referred to as descriptions. Each of the descriptions is input by the administrator of the corresponding transaction object. Each description can be freely written by the corresponding administrator. The description is an example of an original text before editing. In other words, the description obtaining unit 30A obtains original texts. The description obtaining unit 30A is an example of an original text obtaining unit.

The description obtaining unit 30A may obtain a description of a travel service input by the administrator of a transaction object from the first travel management server 12A. Specifically, the description obtaining unit 30A may obtain a description of a travel service that is related to a travel in the first country and written in the first language.

The guideline obtaining unit 30B obtains a guideline from the memory 31. The guideline includes one or multiple rules related to summarization of descriptions. Specifically, the guideline includes one or multiple rules related to how to summarize a description, rather than an instruction requesting that the description be summarized. The guideline may include, for example, one or multiple of a content selection rule, a grouping rule for grouping pieces of content having the same theme, an ordering rule for specifying the order of sentences, and a modification rule for textual expressions.

The guideline may be set by the operator of the information processing system 10 instead of the administrator of the transaction object. For example, the guideline may be set by the administrator of the information processing device 11.

The information transmission unit 30C is configured to transmit information to the LLM servers 17. For example, the information transmission unit 30C transmits the guideline together with a description to the LLM servers 17. The transmitted description and guideline are input to the summarization model. Then, the summarization model outputs a summary of the transaction object in which the description is summarized in accordance with the guideline. Hereinafter, a summary of a transaction object will simply be referred to as a summary. The information transmission unit 30C may be configured to transmit information via an application programming interface (API).

The information receiving unit 30D is configured to receive information from the LLM servers 17. For example, when an LLM server 17 transmits a summary output from the summarization model, the information receiving unit 30D receives the summary. The information receiving unit 30D may be configured to receive information via an API.

The summary obtaining unit 30E obtains the summary received by the information receiving unit 30D. The summary is an example of an edited text obtained by editing an original text, and the summary obtaining unit 30E is an example of an edited text obtaining unit.

The summary obtaining unit 30E may obtain a summary generated through multiple stages (for example, two stages). In this case, multiple rules included in the guideline may be divided into a first guideline used in the first stage and a second guideline used in the second stage. For example, the first guideline may include at least one of the selection rule, the ordering rule, and the grouping rule, and the second guideline may include the modification rule.

At the first stage, the summary obtaining unit 30E may obtain an intermediate summary obtained by summarizing the description in accordance with the first guideline. At the subsequent second stage, the summary obtaining unit 30E may obtain a final summary obtained by further editing the intermediate summary in accordance with the second guideline.

The translated text obtaining unit 30F obtains a translated text of the transaction object obtained by translating the summary. In particular, the translated text obtaining unit 30F obtains the translated text output by the translation model by transmitting the summary to the translation model. For example, when the summary is written in the first language for a travel in the first country, the translation model outputs a translated text written in the second language for the travel in the first country.

The evaluation unit 30G evaluates each of multiple summaries. Through this evaluation, the evaluation unit 30G verifies whether each summary has been generated in accordance with the rules specified in the guideline. The evaluation model outputs an evaluation result as to whether the edited text (summary) has been edited from the original text (description) in accordance with the guideline. The evaluation unit 30G transmits the guideline applied to the summary to the evaluation model together with the description and the summary, and evaluates whether the summary has been generated in accordance with the guideline. Even when the guideline includes multiple rules, the evaluation may be performed using one of the rules as an evaluation criterion. That is, the evaluation may be performed for each rule.

In a case in which the summary of the description is performed in stages, the evaluation unit 30G may perform an evaluation for each of multiple stages. In this case, the evaluation unit 30G evaluates whether the summary has been generated in accordance with the rule applied to each stage. At the time of evaluation, the evaluation unit 30G may transmit a guideline including a rule used as the evaluation criterion to the evaluation model together with the original text and the edited text. The edited text in the first stage corresponds to an intermediate summary, and the original text in the second stage corresponds to the intermediate summary.

The information providing unit 30H provides a summary so that it is viewable for prospective users. In the summary, the content may be summarized for each prescribed item in accordance with the guideline. The prescribed items may be set based on guideline items, which will be discussed below. The guideline items are specified in the guideline.

The information providing unit 30H may transmit a summary written in the first language or a text translated into the second language to the second travel management server 12B. The transmitted summary and the translated text are provided, for example, through a website so as to be viewable for prospective users of the transaction object.

The guideline modifying unit 30I modifies the guideline related to summaries of descriptions based on the result of evaluation by the evaluation unit 30G. For example, when there are rules that are not reflected in a large number of summaries, the rules are not effective for optimization of summaries. The accuracy of summaries is improved by repeating feedback for deleting or modifying such ineffective rules.

### Information Processing by Information Processing System 10

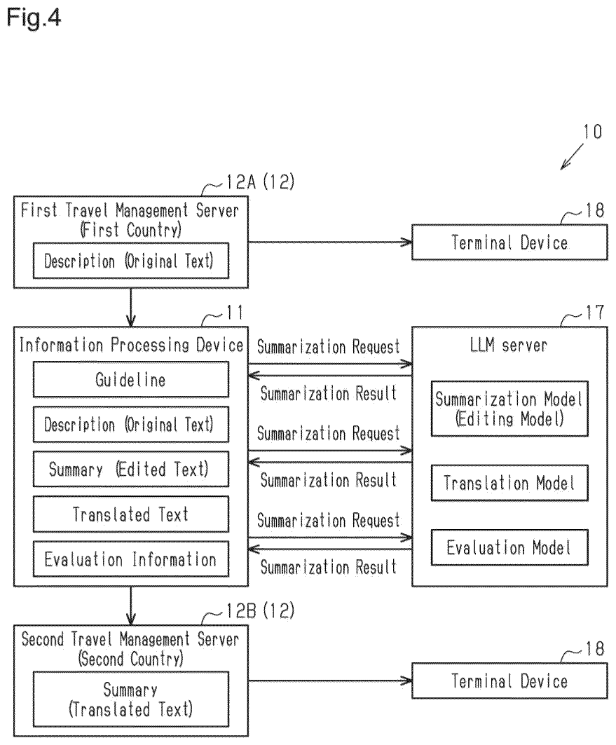

Information processing by the information processing system 10 will be described with reference to FIG. 4.

As shown in FIG. 4, in the information processing system 10, the first travel management server 12A manages descriptions related to the first country. In particular, the first travel management server 12A provides information related to travel services in the first country written in the first language in a viewable manner. The first travel management server 12A may provide a website of travel services in countries or regions where the first language is spoken, and information including descriptions or summaries may be posted on the website. The first travel management server 12A provides users with information on travel services in the first country written in the first language in response to a request from the terminal device 18.

The second travel management server 12B manages descriptions related to the second country. In particular, the second travel management server 12B provides information related to travel services in the second country written in the second language in a viewable manner. The second travel management server 12B may provide a website of travel services in countries or regions where the second language is spoken, and information including descriptions or summaries may be posted on the website. The second travel management server 12B provides users with information on travel services in the second country written in the second language in response to a request from the terminal device 18.

The information processing device 11 manages the guideline. The information processing device 11 obtains a description from the first travel management server 12A by communicating with the first travel management server 12A. The information processing device 11 transmits, to the LLM servers 17, a summarization request for requesting summarization, the description, and the guideline.

The LLM servers 17 each manage the summarization model. When receiving the summarization request from the information processing device 11, the LLM servers 17 each input the description and the guideline to the summarization model. The summarization model outputs, as a summarization result, a summary obtained by summarizing the description in accordance with the guideline. The LLM servers 17 each transmit the summarization result output from the summarization model to the information processing device 11. The summarization result includes a summary written in the first language.

The information processing device 11 receives the summarization result from the LLM servers 17. The information processing device 11 receives the summary included in the summarization result from the LLM servers 17. As a result, the information processing device 11 obtains the summary generated in accordance with the guideline.

When generating a summary in stages, the information processing device 11 may first obtain an intermediate summary generated in accordance with the first guideline. Thereafter, the information processing device 11 obtains a final summary generated in accordance with the second guideline.

The information processing device 11 transmits, to the LLM servers 17, a translation request for requesting translation, the summary written in the first language obtained from the LLM servers 17, and information indicating the target language (the second language).

The LLM servers 17 each manage the translation model. When receiving the translation request from the information processing device 11, the LLM servers 17 input the summary and the target language to the translation model. The translation model translates the input summary into the second language and outputs the translation result. The LLM servers 17 each transmit the translation result to the information processing device 11. The translation result includes a text translated into the second language.

The information processing device 11 receiving the translation result from the LLM servers 17 to obtain the translated text. The information processing device 11 transmits the obtained translated text to the second travel management server 12B.

The second travel management server 12B receives the translated text from the information processing device 11. The second travel management server 12B manages the translated text of a travel service in the first country translated into the second language in a viewable manner, in addition to or instead of a description of a travel service in the second country written in the second language. This translated text includes sentences obtained by translating the summary of the travel service in the first country into the second language. The second travel management server 12B provides the summary of the travel service in the first country written in the second language to a user in response to a request from the device 18.

The information processing device 11 transmits, to the LLM servers 17, an evaluation request for requesting evaluation, a description, a guideline, and a summary.

The LLM servers 17 each manage the evaluation model. When receiving the evaluation request from the information processing device 11, the LLM servers 17 each input the description, the guideline, and the summary into the evaluation model. The evaluation model outputs an evaluation result as to whether the summary has been generated from the description in accordance with the guideline. The LLM servers 17 each transmit the evaluation result output from the evaluation model to the information processing device 11.

The information processing device 11 receives the evaluation result from the LLM servers 17 to obtain the evaluation result for the summary. The information processing device 11 may modify the guideline based on the evaluation result.

### Guideline

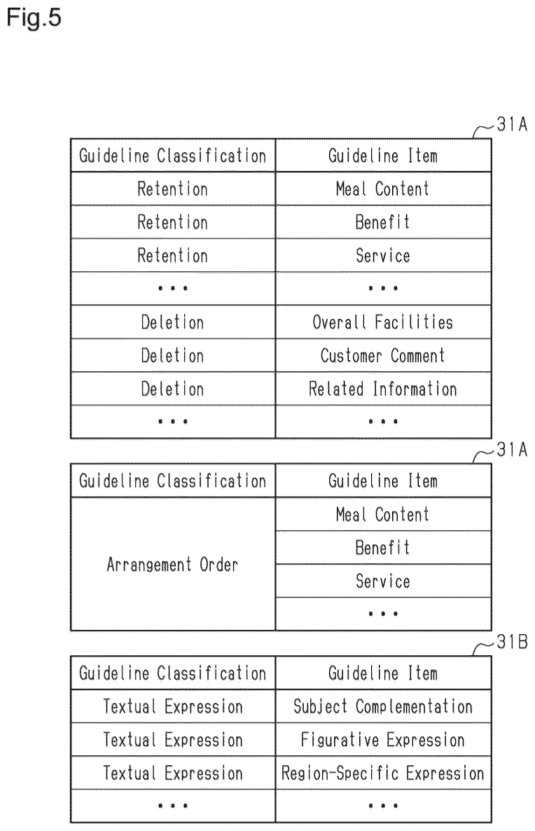

Next, an example of the guideline will be described with reference to FIG. 5.

As shown in FIG. 5, the guideline is stored in the memory 31. The guideline includes multiple rules for summarization. The guideline includes multiple guideline classifications, and each guideline classification includes one or multiple guideline items. The guideline classifications indicate the classifications of the rules related to summarization. A name that represents the corresponding rule is given to each guideline item.

The guideline may include a first guideline 31A and a second guideline 31B. The first guideline 31A may include a selection rule related to selection of content to be retained in summaries. The selection rule specifies at least one of content to be deleted from the original text and content to be retained in the summary. The selection of content may be conducted at the level of sentences, phrases, or words. The selection rule may specify specific symbols, lines, or emojis used for embellishment in a text as content to be removed.

The first guideline 31A may include an ordering rule that specifies an arrangement order of sentences. When multiple sentences related to multiple guideline items are included in the original text, the ordering rule specifies the order of the sentences for each guideline item.

The first guideline 31A includes an adjustment rule related to a prescribed item for integrating multiple sentences. When there are multiple sentences written for the same theme or similar themes, the prescribed item is set to group the sentences for each theme. That is, the grouping rule specifies a method of grouping multiple sentences according to the prescribed item. In the present disclosure, more than one guideline items are set as prescribed items.

The second guideline 31B includes a modification rule of textual expressions. The modification rule specifies a method of modifying textual expressions included in the original text.

The guideline classification of the first guideline 31A may include at least one of “retention” and “deletion” corresponding to the rule for content selection. “Retention” specifies that the content related to a designated guideline item be retained in the summary. A guideline item whose guideline classification is “retention” is also referred to as a retention item. Examples of the retention items include, but are not limited to, meal content, benefit, and service. Each of the retention items is also a prescribed item.

“Deletion” specifies that the content related to a designated guideline item be deleted so as not to be retained in the summary. A guideline item whose guideline classification is “deletion” is also referred to as a deletion item. Examples of the deletion item include, but are not limited to, overall facilities (e.g., inside facilities, parking information, access information, and nearby sightseeing information), customer comment, and related information (e.g., overall cancel policy and catch phrase).

The guideline classification of the first guideline 31A may include “arrangement order” corresponding to the ordering rule. When there are multiple sentences related to multiple guideline items, the “arrangement order” specifies the arrangement order of the sentences for each unit of the guideline items. In the “arrangement order”, for example, the arrangement order of the retention items may be specified in the order of meal content, benefit, and service. The multiple guideline items whose order is specified by the “arrangement order” are also prescribed items.

The guideline classifications of the second guideline 31B may include an “textual expression” corresponding to the modification rule. Each of the one or multiple designated items to which the “textual expression” is set specifies a rule for modifying the textual expression in the original text. Examples of the guideline item whose guideline classification is “textual expression” include, but are not limited to, subject complementation, figurative expression, and region-specific expression. The region-specific expression refers to a textual expression specific to a region or an expression that reflects the cultural background of the region.

### Examples of Description, Summary, and Translated Text

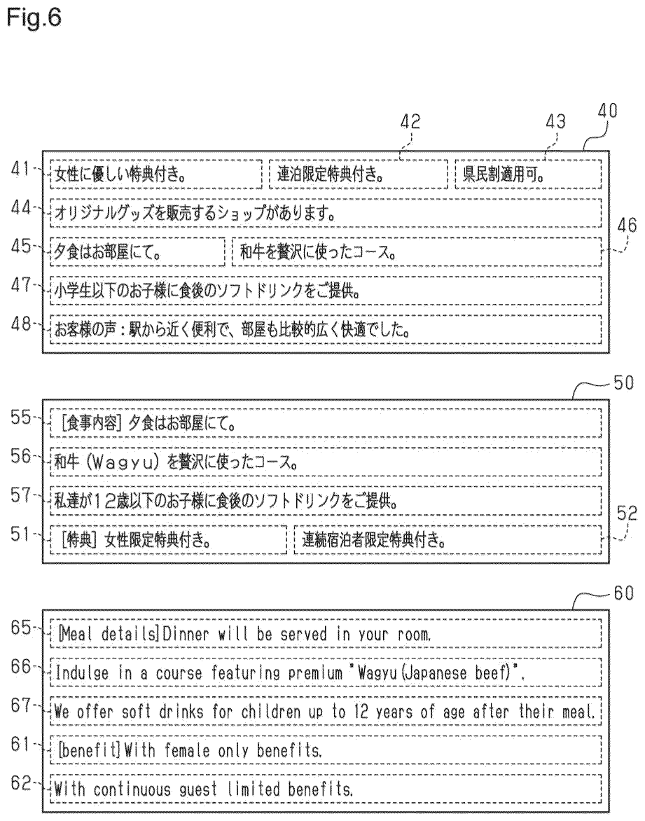

Next, examples of a description, a summary, and a translated text will be described with reference to FIG. 6.

As shown in FIG. 6, the first text 40 includes exemplary descriptions. The first text 40 is input by the administrator of the transaction object who provides a travel service. The first text 40 includes multiple sentences 41 to 48.

The first text 40 includes sentences 41 to 43 about benefits. The first text 40 includes a sentence 44 about overall facilities of a Japanese inn. The first text 40 includes sentences 45 to 47 about the meal content. The first text 40 includes a sentence 48 related to customer comments.

The second text 50 includes exemplary summaries obtained by summarizing the first text 40 in accordance with the guideline. The second text 50 includes sentences 51, 52, and 55 to 57.

The second text 50 includes sentences 55 to 57 related to the meal content and sentences 51, 52 related to the benefits. Thus, the sentences corresponding to the retention items are retained in the summary in accordance with the selection rule.

The second text 50 does not include the sentence 44 about the overall facilities of the Japanese inn. The second text 50 does not include the sentence 48 related to customer comments. In this manner, the sentences corresponding to the deletion items are deleted from the original text in accordance with the selection rule, so that these sentences are not retained in the summary.

In the second text 50, the sentences 55 to 57, which correspond to the meal content as the prescribed items, are arranged consecutively. In the second text 50, the sentences 51,52, which correspond to benefits as the prescribed items, are arranged consecutively. In this manner, the multiple sentences included in the summary are grouped for each prescribed item in accordance with the grouping rule.

The sentences 55, 56, 57, 51, and 52 included in the second text 50 are arranged in that order, that is, all of the sentences 55 to 57 related to the meal content are arranged before all of the sentences 51, 52 related to the benefits. The arrangement order of the sentences included in the summary is adjusted for each guideline item in accordance with the ordering rule.

The second text 50 includes sentences in which missing subjects in the first text 40 are complemented according to the “subject complementation” of the modification rule. For example, the second text 50 includes a sentence obtained by expanding an abbreviation in the first text 40. Specifically, the abbreviation (renpaku) in the original sentence 42, “renpaku gentei tokuten tsuki (with continuous stay limited benefits)” is expanded into “renzoku shukuhakusha”. The expanded phrase “renzoku shukuhakusha (continuous guest)” is used as the subject in the sentence 52 “renzoku shukuhakusha gentei tokuten tsuki (with continuous guest limited benefits)”.

The second text 50 includes a sentence in which a figurative expression in the first text 40 has been modified in accordance with the “figurative expression” of the modification rule. Specifically, the original sentence 41 “Josei ni yasashii tokuten tsuki (with a benefit friendly to women)” is modified to the sentence 51, which includes a textual expression “Josei gentei tokuten tsuki (with a benefit limited to women)”.

The second text 50 includes a sentence obtained by modifying a region-specific expression in the first text 40 in accordance with the “region-specific expression” of the modification rule. “The region-specific expression” refers to a process of changing a textual expression in the original language that would not make sense if directly translated into the target language, to a textual expression that can be understandable in the target language. For example, when translating ideographic characters like Kanji into a phonetic language that uses the alphabet, it is acceptable to express the sound of the original language in letters of the target language. For example, in the sentence 56, the term “Japanese beef” written in Kanji in the sentence 46 is supplemented with the Romanized Japanese reading “Wagyu”.

The sentence 57 is a sentence in which the subject “Watashi-tachi ga (We are)” has been complemented in accordance with the “subject complementation” of the modification rule. The textual expression “Shogakusei ika (elementary school students or younger)” included in the original sentence 47 is modified to the textual expression “12-sai ika (12 years old or younger”) in the sentence 57. Since the ages corresponding to school grades vary by country, expressing this in terms of age enables users from diverse backgrounds to appropriately understand the meaning of the text.

The second text 50 has been revised according to the “region-specific expression” of the modification rule, resulting in the deletion of the textual expression “Kenmin wari tekiyo ka (eligible for a prefectural resident discount)” found in the original sentence 43. The sentence 43 is a sentence about a benefit, but is deleted because “Ken (prefectural)” is a region-specific expression. As described above, the method of modifying a text may include deletion of sentences.

The third text 60 is an example of a translated text. The third text 60 obtained by translating the second text 50 in Japanese into English. The third text 60 includes sentences 65, 66, 67, 61, and 62 respectively corresponding to the sentences 55, 56, 57, 51, and 52.

In the translated text, in principle, multiple sentences included in the summary are translated on a sentence-by-sentence basis. Therefore, the arrangement order of the multiple sentences included in the summary is maintained so as not to change from the summary, which is the original text. For example, in the third text 60, similarly to the second text 50, the sentences 65 to 67 corresponding to the meal content as the prescribed items are grouped together. In the third text 60, similarly to the second text 50, the sentences 61 and 62, corresponding to benefit, which is the prescribed item, are grouped together.

### Evaluation Result Information 31C

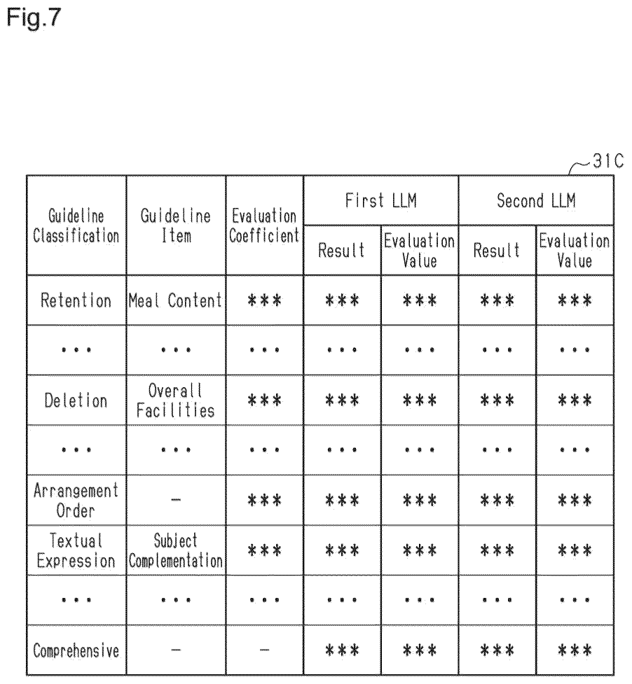

Next, an example of the evaluation result information 31C including the evaluation results will be described with reference to FIG. 7.

As shown in FIG. 7, the evaluation result information 31C is stored in the memory 31. The evaluation result information 31C is managed in the information processing device 11. The evaluation result information 31C includes evaluation results obtained from the LLM servers 17. The evaluation result information 31C may be generated each time a summary is obtained from a description. When a summary is generated in stages, the evaluation result information 31C may include an evaluation result for the summary (an intermediate summary and a final summary) generated in each stage.

The evaluation result information 31C includes information related to each of the guideline classification, the guideline item, an evaluation coefficient, the first evaluation result and the evaluation value from the first LLM server 17A, and the second evaluation result and the evaluation value from the second LLM server 17B.

The evaluation coefficient is a coefficient for weighting evaluation results. The evaluation coefficient can be set by the operator of the information processing system 10. The evaluation coefficient is set to a larger value for an evaluation result desired to be emphasized than for an evaluation result desired to be downplayed. Alternatively, the evaluation coefficient may set to a larger value for a more common index item than for an index item having a relatively low appearance frequency.

The evaluation includes “appropriate” and “inappropriate”. When the edited text is appropriately generated according to the guideline, the evaluation is “appropriate”. When the edited text deviates from the guideline, the evaluation is “inappropriate”. The evaluation may be performed for each rule and for each guideline item.

For example, regarding the selection rule, if the content included in the original text is selected according to the selection rule, the evaluation is “appropriate”, and if not, the evaluation is “inappropriate”. Regarding the ordering rule, in a case in which the original text includes sentences related to multiple designated items, if the sentences related to the respective designated items are arranged in the edited text according to the ordering rule, the evaluation is “appropriate”, and if not, the evaluation is “inappropriate”. Regarding the grouping rule, in a case in which multiple sentences are included in the original text, if the sentences are grouped for each prescribed item in the edited text, the evaluation is “appropriate”, and if not, the evaluation is “inappropriate”. Regarding the modification rule, if the textual expression in the original text is modified according to the modification rule, the evaluation is “appropriate”, and if not, the evaluation is “inappropriate”.

The evaluation may include “invalid”. When the evaluation is “invalid”, the summary is excluded from the evaluation target. “Invalid” indicates that the text corresponding to the guideline classification and the guideline item is not included in the description. Therefore, “invalid” is an evaluation for the original text.

For example, regarding the selection rule, the evaluation of the selection result of the content includes at least one of the evaluation of the selection result of the content related to a retention item and the evaluation of the deletion result of the content related to a deletion item. For example, in a case in which the original text includes one or multiple sentences related to one or multiple retention items, if the content related to the retention item is not included in the original text, the evaluation of the selection result of the edited text generated from the original text is “invalid”. Similarly, in a case in which the original text includes one or multiple sentences related to one or multiple deletion items, if the content related to the deletion item is not included in the original text, the evaluation of the selection result of the edited text generated from the original text is “invalid”.

Regarding the ordering rule, when the original text includes only the content related to one of the multiple designated items for which the order is specified, or when the original text includes no content related to any of the designated items, the corresponding edited text is evaluated as “invalid”.

Similarly, regarding the grouping rule, when the content related to the prescribed item is not included in the original text, the corresponding edited text is evaluated as “invalid”. In addition, regarding the modification rule, when the textual expression corresponding to a modification item related to the guideline item is not included in the original text, the corresponding summary is evaluated as “invalid”.

The evaluation result may be indicated by a score. For example, 1 may indicate that the evaluation result is appropriate, −1 may indicate that the evaluation result is inappropriate, and 0 may indicate that the evaluation result is invalid. The evaluation value is obtained by multiplying the evaluation result by the evaluation coefficient. When the evaluation coefficient is 0 to 1, the evaluation value has a minimum value of −1 and a maximum value of 1. The larger the evaluation value of each index item, the more the edited text conforms to the corresponding rule.

When each LLM server 17 obtains multiple evaluation results respectively corresponding to multiple edited texts, the evaluation results or evaluation values may be aggregated for each rule. The larger the aggregate value for each rule is, the greater the number of the index items that have been edited according to the rule. Instead of this, or in addition to this, the evaluation results or evaluation values may be aggregated for each index item. A larger aggregate value indicates that the index item is edited in accordance with a larger number of rules. Furthermore, a comprehensive evaluation result and a comprehensive evaluation value may be calculated for these edited texts. The comprehensive evaluation result and the comprehensive evaluation value may be aggregate values of the evaluation results and the evaluation values for all the rules and all the index items.

The aggregate value of evaluation results may be an average or a total of the evaluation results. The aggregate value of evaluation values may be an average value or an aggregate value of all the evaluation values that have been evaluated. The evaluation value, the aggregate value, or the comprehensive evaluation value may be calculated separately for each of the first evaluation result and the second evaluation result.

### Summarization Controlling Process

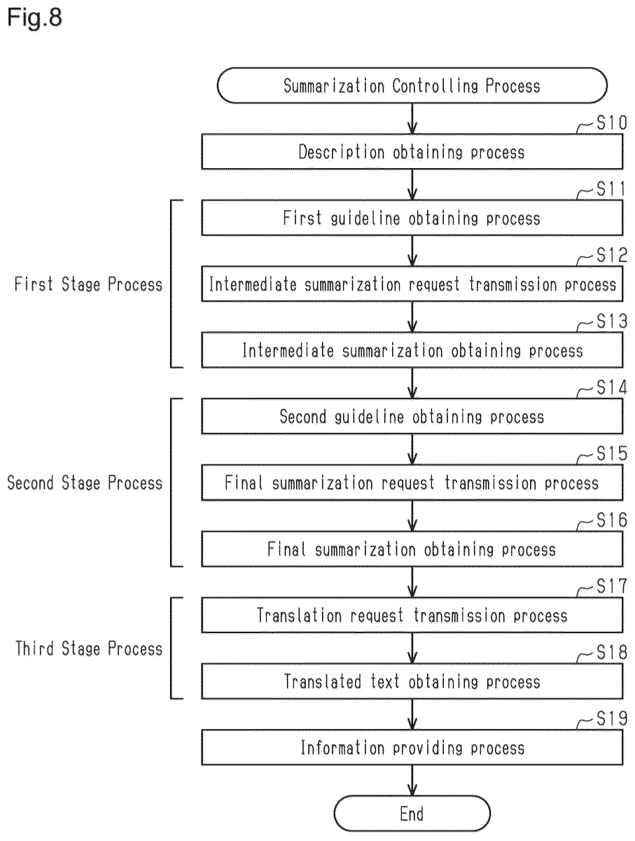

Next, the summarization controlling process will be described with reference to FIG. 8. The summarization controlling process is executed by the control unit 30 when a summarization condition is met. The summarization condition may be met by an instruction from the operator of the information processing system 10.

As shown in FIG. 8, in step S10, the control unit 30 executes a description obtaining process. In the description obtaining process, the control unit 30 obtains a description from the first travel management server 12A by communicating with the first travel management server 12A. In this case, the control unit 30 obtains, from the first travel management server 12A, a description written in the first language related to a travel service in the first country. The description is input by the administrator who provides the travel service.

In step S11, the control unit 30 executes a first guideline obtaining process. In the first guideline obtaining process, the control unit 30 obtains the first guideline 31A by retrieving the first guideline 31A, related to a summary of the description, from the memory 31.

In step S12, the control unit 30 executes a first summarization request transmission process. In the first summarization request transmission process, the control unit 30 transmits a first summarization request to the LLM servers 17. The control unit 30 may transmit the first summarization request to either the first LLM server 17A or the second LLM server 17B.

At this time, the control unit 30 generates a first prompt to be input to the summarization model, and transmits the first prompt to the LLM servers 17 together with the first summarization request. The first prompt includes a description, the first guideline 31A, and a first directive. The first guideline 31A includes the selection rule, the grouping rule, and the ordering rule. The first directive includes an instruction to summarize the description in accordance with the rules specified in the first guideline 31A.

When receiving the first summarization request, the LLM servers 17 each input the first prompt into the summarization model. The summarization model selects designated content from the description in accordance with the first directive, and then generates an intermediate summary in which the order of sentences is adjusted for each prescribed item. The LLM servers 17 each transmit the intermediate summarization result including the intermediate summary to the information processing device 11.

In step S13, the control unit 30 executes an intermediate summary obtaining process. In the intermediate summary obtaining process, the control unit 30 obtains the intermediate summary by receiving the intermediate summarization result from the LLM servers 17. In this manner, the control unit 30 obtains the intermediate summary generated according to the first guideline 31A. The intermediate summary is written in the first language. The control unit 30 stores the obtained intermediate summary in the memory 31.

As described above, the control unit 30 transmits the description and the guideline to the summarization model to obtain the intermediate summary, which is generated by summarizing the description.

The control unit 30 executes the processes of steps S11 to S13 as a first stage process. In the intermediate summary obtained in the first stage process, the content in the description is selected in accordance with the selection rule, and the arrangement order of the sentences is adjusted for each prescribed item according to the grouping rule and the ordering rule.

In step S14, the control unit 30 executes a second guideline obtaining process. In the second guideline obtaining process, the control unit 30 obtains the second guideline 31B by retrieving the second guideline 31B from the memory 31.

In step S15, the control unit 30 executes a final summarization request transmission process. In the final summarization request transmission process, the control unit 30 transmits a final summarization request to each LLM server 17. The control unit 30 may transmit the final summarization request to either the first LLM server 17A or the second LLM server 17B.

At this time, the control unit 30 generates a second prompt to be input to the summarization model, and transmits the second prompt to the LLM servers 17 together with the final summarization request. The second prompt includes an intermediate summary, the second guideline 31A, and a second directive. The second guideline 31B includes a modification rule. The second directive includes an instruction for modifying the textual expression in the intermediate summary according to the rules specified in the second guideline 31B.

When receiving the final summarization request, each LLM server 17 inputs the second prompt into the summarization model. The summarization model generates a final summary by modifying the textual expression in the intermediate summary according to the second directive. Each LLM server 17 transmits the final summarization result including the final summary to the information processing device 11.

In step S16, the control unit 30 executes a final summary obtaining process. In the final summary obtaining process, the control unit 30 obtains the final summary by receiving the final summarization result from the LLM servers 17. The final summary is written in the first language. The control unit 30 stores the obtained final summary in the memory 31.

The control unit 30 executes the processes of steps S14 to S16 as a second stage process. In the second stage process, the final summary is generated by modifying the textual expression in the intermediate summary according to the modification rule.

In step S17, the control unit 30 executes a translation request transmission process. In the translation request transmission process, the control unit 30 transmits a translation request to the LLM servers 17. The control unit 30 may transmit the translating request to either the first LLM server 17A or the second LLM server 17B.

At this time, the control unit 30 generates a third prompt and transmits the third prompt to the LLM servers 17 together with the translation request. The third prompt includes the final summary, information indicating the target language (the second language), and a third directive. The third directive includes an instruction for translating the final summary written in the first language into the second language.

When receiving the translation request, the LLM servers 17 input the third prompt into the translation model. The translation model generates a translated text obtained by translating the final summary into the second language in accordance with the third directive. The LLM server 17 transmits a translation result including the translated text to the information processing device 11.

In step S18, the control unit 30 executes a translated text obtaining process. In the translated text obtaining process, the control unit 30 obtains the translated text by receiving the translated result from the LLM servers 17. In this case, the control unit 30 obtains a translated text that has been generated by translating the final summary into the second language. Specifically, the control unit 30 obtains, as the translated text, a summary written in the second language related to a travel service in the first country. The control unit 30 stores the obtained translated text in the memory 31.

In this manner, the control unit 30 executes the processes of steps S17 and S18 as a third stage process. In the third stage process, the summary is translated into another language.

In step S19, the control unit 30 executes an information providing process. In the information providing process, the control unit 30 transmits the obtained translated text to the second travel management server 12B. The second travel management server 12B causes the received translated text to be viewable. For example, the second travel management server 12B provides users with information on a travel service by uploading the translated text to a website. The information processing device 11 may generate a summary and a translated text automatically or in real time when the administrator inputs a description. The second travel management server 12B may then automatically or in real-time upload the translated text to the website.

Since, in the summary, which served as the basis for the translated text, specified content is grouped according to the prescribed items, the specified content is grouped according to the prescribed items in the translated text. Accordingly, the second travel management server 12B makes the received translated text to be viewable for the prescribed items. In other words, the control unit 30 provides a summary for each prescribed item in such a way that the summary is viewable for prospective users of the transaction object. In particular, the control unit 30 provides a translated text, which is a summary translated into a different language, to prospective users of the transaction object.

### Evaluation Controlling Process

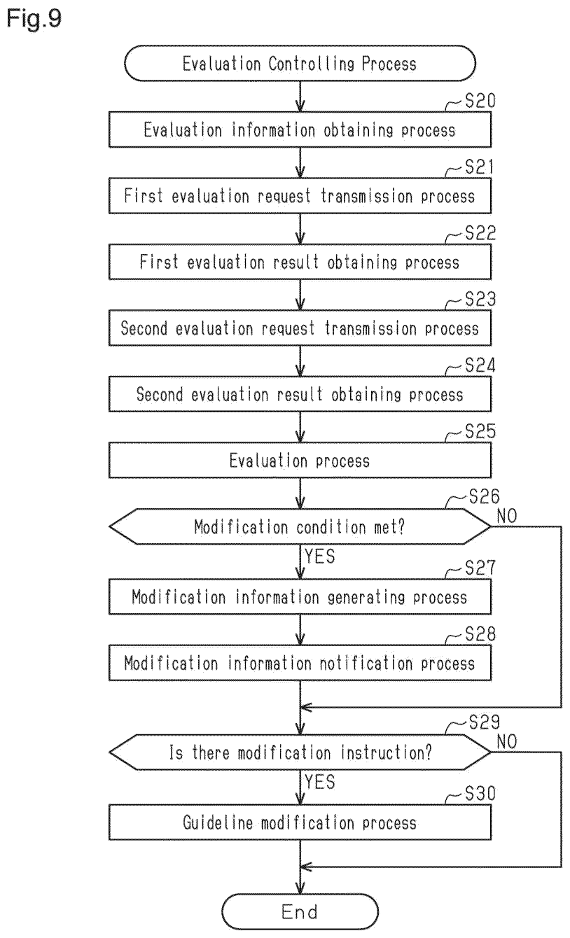

Next, the evaluation controlling process will be described with reference to FIG. 9. The evaluation controlling process is executed by the control unit 30 when an evaluation condition is met. The evaluation condition may be met by an instruction from the operator of the information processing system 10. The evaluation condition may be met when a summary of a description is obtained.

In step S20, the control unit 30 executes an evaluation information obtaining process. In the evaluation information obtaining process, the control unit 30 retrieves the description, the guideline, and the summary as evaluation information from the memory 31. Thus, the control unit 30 obtains the description, the guideline, and the summary.

In step S21, the control unit 30 executes a first evaluation request transmission process. In the first evaluation request transmission process, the control unit 30 transmits a first evaluation request to the first LLM server 17A. The first evaluation request is an evaluation request transmitted to the first LLM server 17A.

The control unit 30 transmits the guideline including rules corresponding to the description obtained as the evaluation information and the summary to the first LLM server 17A together with the first evaluation request. As a result, the control unit 30 obtains an evaluation to determine whether the summary is “appropriate”, “inappropriate”, or “invalid” for each rule and each guideline item.

Specifically, after generating an evaluation prompt to be input to the first evaluation model, the control unit 30 transmits the evaluation prompt to the first LLM server 17A together with the first evaluation request. The evaluation prompt includes the description, a rule in the guideline that is used as an evaluation criterion, a guideline item that is used as an evaluation criterion, a summary, and a directive. The directive includes an instruction for evaluating the guideline item to be evaluated included in the summary according to a rule in the guideline that is used as an evaluation criterion.

When receiving the first evaluation request, the first LLM server 17A inputs the evaluation prompt into the first evaluation model. The first evaluation model outputs a first evaluation result as to whether the summary has been summarized from the description in accordance with the corresponding rule. The first LLM server 17A transmits the output first evaluation result to the information processing device 11.

In step S22, the control unit 30 executes a first evaluation result obtaining process. In the first evaluation result obtaining process, the control unit 30 receives the first evaluation result from the first LLM server 17A.

The control unit 30 stores the first evaluation result in the memory 31 as a part of the evaluation result information 31C. Further, the control unit 30 calculates an evaluation value by multiplying the first evaluation result by the evaluation coefficient. The control unit 30 stores the calculated evaluation value in the memory 31 as a part of the evaluation result information 31C.

In step S23, the control unit 30 executes a second evaluation request transmission process. In the second evaluation request transmission process, the control unit 30 transmits a second evaluation request to the second LLM server 17B. The second evaluation request is an evaluation request transmitted to the second LLM server 17B.

The control unit 30 transmits the guideline including the rule corresponding to the description obtained as the evaluation information and the summary to the second LLM server 17B together with the second evaluation request. As a result, the control unit 30 obtains an evaluation to determine whether the summary is “appropriate”, “inappropriate”, or “invalid” for each rule and each guideline item. The information transmitted to the first LLM server 17A and the information transmitted to the second LLM server 17B may be the same information.

Specifically, after generating an evaluation prompt to be input to the second evaluation model, the control unit 30 transmits the evaluation prompt to the second LLM server 17B together with the second evaluation request. When receiving the second evaluation request, the second LLM server 17B inputs the evaluation prompt into the second evaluation model. The second evaluation model outputs a second evaluation result as to whether the summary has been summarized in accordance with the corresponding rule. The second LLM server 17B transmits the output second evaluation result to the information processing device 11.

In step S24, the control unit 30 executes a second evaluation result obtaining process. In the second evaluation result obtaining process, the control unit 30 receives the second evaluation result from the second LLM server 17B. In this manner, the control unit 30 obtains the first and second evaluation results output by the first and second evaluation models, respectively.

When the same summary is input to each of the first evaluation model and the second evaluation model, which are different from each other, the difference between the first evaluation result and the second evaluation result is caused by the evaluation accuracy of the first evaluation model and the second evaluation model. When the first evaluation model is caused to evaluate the first summary and the second evaluation model is caused to evaluate the second summary, the difference between the first evaluation result and the second evaluation result includes the difference in the summarization accuracy between the first summarization model and the second summarization model.

The control unit 30 stores the obtained second evaluation result in the memory 31 as a part of the evaluation result information 31C. Further, the control unit 30 calculates the evaluation value by multiplying the second evaluation result by the evaluation coefficient. The control unit 30 stores the calculated evaluation value in the memory 31 as a part of the evaluation result information 31C.

In step S25, the control unit 30 executes an evaluation process. In the evaluation process, the control unit 30 aggregates evaluation values based on the evaluation result information 31C stored in the memory 31. For example, the control unit 30 aggregates multiple evaluation values stored in the memory 31 for each rule or for each guideline item, or calculates a comprehensive evaluation value.

For example, for the selection rule, the control unit 30 evaluates the selection result of the content based on at least one of the selection result of the content related to the retention item and the deletion result of the content related to the deletion item. For example, the control unit 30 evaluates whether the information to be retained in the summary is properly included based on the aggregate value of the retention items. Instead of this or in addition to this, the control unit 30 evaluates whether the content to be deleted has been properly deleted in the process of summarization based on the aggregate value of the deletion items.

For each of the retention items and the deletion items, when the summary is evaluated as either “appropriate” or “inappropriate”, the summary is an evaluation target for the selection result. Specifically, if the evaluation is “appropriate”, the score of the evaluation result is set to 1, and if the evaluation is “inappropriate”, the score of the evaluation result is set to −1. Therefore, the evaluation result is reflected in the aggregate value for the selection rule.

When the evaluation is “invalid” for each of the retention items and the deletion items, the content to be retained or deleted is not included in the description, which is the original text. In this case, since the evaluation result score is 0, the evaluation value is also 0. As a result, the summary generated from the description is excluded from the evaluation target for the selection result.

For each of multiple other rules, the control unit 30 may evaluate each rule by calculating an aggregate value for each guideline item. For example, for the ordering rule, the control unit 30 evaluates whether multiple sentences included in the summary are arranged in accordance with the ordering rule. For the grouping rule, the control unit 30 evaluates whether multiple sentences included in the summary are grouped in accordance with the grouping rule. For the modification rule, the control unit 30 evaluates whether the textual expression in the summary has been modified in accordance with the modification rule.

The control unit 30 may compare a first evaluation value calculated from the first evaluation result with a second evaluation value calculated from the second evaluation result. The comparison may be performed for each rule or for each designated item.

In step S26, the control unit 30 determines whether a modification condition for modifying the guideline is met. The modification condition is met based on the evaluation result. Specifically, the modification condition is met based on the evaluation value.

The modification condition may be met based on the first evaluation result and the second evaluation result. The modification condition may be met when there is a guideline item for which both the first evaluation value calculated from the first evaluation result and the second evaluation value calculated from the second evaluation result are less than or equal to a specified value. The modification condition may be met when there is a guideline item for which at least one of the first evaluation value and the second evaluation value is less than or equal to the specified value. The modification condition may be met when both of the first comprehensive evaluation value and the second comprehensive evaluation value are less than or equal to the specified value. The modification condition may be met when at least one of the first comprehensive evaluation value and the second comprehensive evaluation value is less than or equal to the specified value.

When determining that the modification condition is not met, the control unit 30 advances the process to step S29. When determining that the modification condition is met, the control unit 30 advances the process to step S27.

In step S27, the control unit 30 executes a modification information generating process. In the modification information generating process, the control unit 30 generates modification information for modifying the guideline. The modification information may include a guideline item for which both the first evaluation value and the second evaluation value are less than or equal to the specified value.

In step S28, the control unit 30 executes a modification information notification process. In the modification information notification process, the control unit 30 communicates the generated modification information. For example, the control unit 30 may notify an operation terminal device managed by the operator of the information processing system 10 of the modification information.

In step S29, the control unit 30 determines whether there is a modification instruction. The modification instruction may be input by the operator of the information processing system 10. The modification instruction may include a modification target and modification content. When determining that there is no modification instruction, the control unit 30 ends the evaluation control process. When determining that there is a modification instruction, the control unit 30 advances the process to step S30.

In step S30, the control unit 30 executes a guideline modification process. In the guideline modification process, the control unit 30 modifies the guideline based on the modification instruction. The control unit 30 updates the guideline by storing the modified guideline in the memory 31. In this manner, the control unit 30 modifies the guideline related to the summary of the description based on the evaluation result.

### Operation and Advantages of First Embodiment

Operation and advantages of the first embodiment will now be described.
(1-1) The control unit 30 transmits the guideline to the summarization model together with the description input by the administrator. The summarization model generates a summary in accordance with the guideline. Thus, the control unit 30 obtains an appropriate summary generated in accordance with the guideline. This improves the accuracy of summarization from the description input by the administrator.
(1-2) The guideline includes the selection rule related to selection of content to be retained in the summary. Thus, the summarization model generates a summary that includes unified content. This allows for the provision of an appropriate summary from which unnecessary information has been removed and that includes content specified by the selection rule.
(1-3) The guideline includes the ordering rule, which specifies the arrangement order of sentences. The summarization model thus generates a summary in which the order of the sentences is adjusted. This allows for the provision of a highly accurate summary with an aligned order of content.
(1-4) The guideline includes the modification rule, which defines a method for modifying a textual expression. Thus, the summarization model generates a summary in which the textual expression is appropriately modified. This allows for the provision of a highly accurate summary with an appropriate textual expression.
(1-5) The control unit 30 provides a summary for each prescribed item in such a way that the summary is viewable for prospective users of the transaction object. Accordingly, a highly accurate summary is provided to the prospective users of the transaction object.
(1-6) The control unit 30 provides a translated text, which is obtained by translating a summary into a different language, to prospective users of the transaction object in a viewable manner. Therefore, the summary translated into a desired language is provided to the users.
(1-7) Conventionally, there has been a desire to appropriately evaluate whether a summary desired by an operator of the information processing system 10 has been obtained. In this regard, the control unit 30 obtains an evaluation result as to whether the summary has been generated in accordance with the guideline using the evaluation model. Thus, it is possible to determine whether an appropriate summary has been obtained based on the evaluation result.
(1-8) The control unit 30 evaluates the selection result of the content by transmitting the description, the guideline, and the summary to the evaluation model of the generative artificial intelligence. Thus, it is possible to determine whether an appropriate summary from which unnecessary content has been removed has been obtained based on the evaluation result.
(1-9) In a case in which content that should be retained is not included in the description, the control unit 30 excludes the summary generated from the description from the evaluation target for the selection result. By selecting the evaluation target in this manner, the accuracy of the evaluation of the selection result is improved.
(1-10) In a case in which content that should be deleted is not included in the description, the control unit 30 excludes the summary generated from the description from the evaluation target for the deletion result. By selecting the evaluation target in this manner, the accuracy of the evaluation of the deletion result is improved.
(1-11) The control unit 30 transmits the guideline including the ordering rule together with a description and a summary to the evaluation model, thereby obtaining an evaluation result as to whether the summary has been generated in accordance with the ordering rule. Thus, it is possible to determine whether an appropriate summary in which the sentences are arranged as specified has been obtained based on the evaluation result.
(1-12) The control unit 30 transmits the guideline including the modification rule together with a description and a summary to the evaluation model, thereby obtaining an evaluation result as to whether the summary has been generated in accordance with the modification rule. Thus, it is possible to determine whether a summary having an appropriate textual expression has been obtained based on the evaluation result.
(1-13) The control unit 30 evaluates a summary based on the evaluation value, which is calculated from the evaluation result output by the evaluation model and the evaluation coefficient. This process enables weighting of the evaluation result based on the evaluation coefficient.
(1-14) For each summary, the control unit 30 can obtain the first evaluation result output from the first evaluation model and the second evaluation result output from the second evaluation model. The control unit 30 thus can determine whether an appropriate summary has been obtained based on both the first evaluation result by the first evaluation model and the second evaluation result by the second evaluation model.
(1-15) The control unit 30 can modify the guideline based on the evaluation results as to whether an appropriate summary has been obtained.

### Second Embodiment

A second embodiment will now be described below. In the description below, the same reference numerals are given to those components that are the same as the corresponding components of the above embodiment. Such elements will not be described or will be briefly described.

In the second embodiment, the first LLM server 17A has a first summarization model, and the second LLM server 17B has a second summarization model. The first summarization model and the second summarization model are learning models different from each other. The control unit 30 obtains a first summary generated by the first summarization model and a second summary generated by the second summarization model from one original text in accordance with the same guideline.

Specifically, the control unit 30 executes the summarization controlling process for the first LLM server 17A. The control unit 30 thus obtains the first summary. In addition, the control unit 30 executes the summarization controlling process for the second LLM server 17B. The control unit 30 thus obtains the second summary.

Thereafter, the control unit 30 evaluates each of the first summary and the second summary based on the same evaluation model. For example, the control unit 30 evaluates the first summary and the second summary by using the first evaluation model of the first LLM server 17A. In this case, in step S21, the control unit 30 transmits a first evaluation request and an evaluation prompt for evaluating the first summary to the first LLM server 17A. Then, in step S22, the control unit 30 obtains a first evaluation result for the first summary.

In step S23, the control unit 30 transmits a second evaluation request and an evaluation prompt for evaluating the second summary to the first LLM server 17A. Then, in step S24, the control unit 30 obtains a second evaluation result for the second summary.

In step S25, the control unit 30 calculates a first evaluation value using the first evaluation result, and calculates a second evaluation value using the second evaluation result. Then, the control unit 30 compares the first evaluation value with the second evaluation value with each other. Based on the comparison result, the control unit 30 determines which of the first summary and the second summary has been generated in accordance with the guideline. If a summary is more in accordance with the guideline, it implies that the summary has been more appropriately summarized, and further indicates that the summarization model that generated this summary has higher summarization accuracy.

In step S25, the control unit 30 may compare the first comprehensive evaluation value for the first summary with the second comprehensive evaluation value for the second summary. For example, when the first comprehensive evaluation value is higher than the second comprehensive evaluation value, it is determined that the summarization accuracy of the first summarization model is higher than that of the second summarization model. Therefore, the first summary generated by the first summarization model with high summarization accuracy may be provided to prospective users.

### Operation and Advantages of Second Embodiment

Operation and advantages of the second embodiment will now be described.
(2-1) The control unit 30 obtains multiple summaries that have been respectively generated from one original text by multiple different summarization models in accordance with the same guideline, and then evaluates the summaries. By comparing the evaluation values for the respective summaries with one another, the control unit 30 relatively evaluates the summarization accuracy among the multiple summaries. This process enables the selection of the summarization model with the highest editing accuracy among multiple editing models to generate a summary. This improves the accuracy of summarization from the description input by the administrator.

### Modifications

The above-described embodiment may be modified as follows. The above-described embodiment and the following modified examples can be combined as long as the combined modifications remain technically consistent with each other.

When the translation condition is met, the control unit 30 may input a summary to the translation model to obtain a translated text. The translation condition may be met by an instruction from the operator of the information processing system 10. The translation condition may be met according to the type of the server that provides the summary. The control unit 30 does not necessarily need to obtain a translated text from the summary.

The control unit 30 may obtain a final edited text from the original text through three or more editing stages. For example, in the first stage, the control unit 30 may transmit a guideline including a selection rule, together with a description, to an LLM server 17 to obtain a first intermediate summary for which content has been selected. In the second stage, the control unit 30 may transmit a guideline including an ordering rule together with the first intermediate summary to the LLM server 17 to obtain a second intermediate summary in which the order of the sentences has been adjusted. In the third step, the control unit 30 may transmit a guideline including a modification rule together with the second intermediate summary to the LLM servers 17 to obtain a final summary in which the textual expression is modified. The rules used in the first to third stages can be changed. For example, a selection rule may be used in the first stage, a modification rule may be used in the second stage, and an ordering rule may be used in the third stage. By inputting corresponding information to the learning model at each of the multiple stages, the accuracy of the learning model is improved. In addition, when multiple rules are individually applied, the amount of information input to the learning model at a time is reduced, which reduces the computation load.

The control unit 30 may execute the first stage process and the second stage process as one process. For example, the control unit 30 may obtain a summary by transmitting a guideline including all the rules together with a description to the LLM servers 17. This reduces the number of inputs to the learning model.

The control unit 30 may evaluate the first summary generated by the first summarization model using the second evaluation model, or may evaluate the second summary generated by the second summarization model using the first evaluation model. That is, the LLM server 17 for obtaining a summary may be different from the LLM server 17 for obtaining an evaluation result.

The evaluation coefficient may be set based on an action history of a prospective transactor in relation to the description and the summary. The evaluation coefficient may be based on the action history of one or multiple prospective transactors. In addition, a high evaluation coefficient may be set for a prescribed item having a high value indicating an action history of one or multiple prospective transactors. The action history may include an impression (IMP). The impression indicates the number of times a prescribed item in a description and a summary has been displayed. The action history may include a click through rate (CTR). The click through rate indicates the ratio of the number of clicks to the number of times the prescribed item in the description and the summary has been displayed. The action history may include a conversion (CV). The conversion indicates the number of times a target action has been initiated starting from a prescribed item in a description and a summary. The conversion includes a completed transaction in a travel service and the purchase of goods or services related to travel. The conversion also includes a completed transaction in an electronic commerce service and the purchase of goods or services in electronic commerce. For example, a higher evaluation coefficient may be set for a prescribed item with a higher impression. A higher evaluation coefficient may be set for a prescribed item with a higher click through rate. A higher evaluation coefficient may be set for a prescribed item with a higher conversion.

Based on the evaluation result, the control unit 30 may select an LLM server 17 with a relatively high editing accuracy as the server for obtaining a summary. In other words, the control unit 30 may select a summarization model with a relatively high editing accuracy based on the evaluation result.

The control unit 30 may retain or delete texts for which the guideline classification corresponds neither “retention” nor “deletion”.

The control unit 30 may execute evaluation based on at least one of the selection rule, the ordering rule, and the modification rule. The control unit 30 may execute one of the evaluation related to the retention items and the evaluation related to the deletion items, and does not necessarily need to execute the other. The control unit 30 may perform an evaluation according to a rule other than the selection rule, the ordering rule, and the modification rule.

The control unit 30 may execute at least one of the selection of content, the arrangement order adjustment of sentences, and the modification of textual expressions as the process for summarizing a description. Regarding the selection of content, the control unit 30 may execute either one of the following: retaining necessary content or deleting unnecessary content, and it is not necessary to execute the other. The control unit 30 may execute a process of editing the original text based on a rule different from the selection rule, the ordering rule, and the modification rule.

The information processing system 10 may provide a service different from travel services. For example, the information processing system 10 may provide an electronic commerce service. In this case, the description of the transaction object may be a description related to a product to be transacted in the electronic commerce service. The information processing system 10 may provide a video distribution service. In this case, the description of the transaction object may be a description related to a video to be transacted in the video distribution service. The information processing system 10 may provide multiple services. The information processing system 10 does not necessarily need to provide travel services. That is, the information processing system 10 may provide a service that is a transaction object. The information processing system 10 does not necessarily need to provide a service that is a transaction object.

The first travel management server 12A and the second travel management server 12B may be provided as an integrated travel management server 12. The multiple travel management servers 12 may include a third travel management server different from the first travel management server 12A and the second travel management server 12B.

The first LLM server 17A and the second LLM server 17B may be provided as an integrated LLM server 17. The multiple LLM servers 17 may include a third LLM server different from the first LLM server 17A and the second LLM server 17B.

The LLM servers 17 may manage at least any two or more of the summarization model, the translation model, and the evaluation model as an integrated learning model. The LLM servers 17 may include another learning model in addition to the summarization model, the translation model, and the evaluation model.

The information processing device 11 may have the configuration of another server. For example, the information processing device 11 may include a part or all of the components related to the travel management servers 12. The information processing device 11 may include a part or all of the components related to the LLM servers 17.

The information processing system 10 may include multiple information processing devices 11. Two or more information processing systems 10 may be provided. Each of the information processing systems 10 may be a server, and the server may be a computer. For example, the multiple servers may include a server that generates a summary from a description based on a guideline. The multiple servers may include a server that generates a translated text from a summary. The multiple servers may include a server that evaluates a summary. The multiple servers may be managed by different administrators or the same administrator.

What is obtained by the information processing device 11 is not limited to a description, and may be any original text. What is obtained by the information processing device 11 is not limited to a summary, and may be an edited text obtained by editing an original text. The guideline does not necessarily need to include rules related to summarization of a description, and may include a rule related to editing of an original text. That is, the information processing device 11 may be configured to obtain an edited text of an original text by inputting the original text and a guideline related to editing of original texts to an editing model.

The information processing device 11 may obtain editing information including an edited image based on original information including an original image and a guideline. In this case, the guideline may include a rule indicating a guidance for retaining the image as an editing rule of the original information. The guideline may include a rule indicating a guidance for deleting the image as an editing rule of the original information.

The expression “at least any” as used herein means “one or multiple” of desired options. As an example, the phrase “at least any” as used herein means only one option if the number of options is two, or both of the two options. As another example, the expression “at least any” used herein means only one option or a combination of any two or more options if the number of options is three or more.

### Clauses

Technical concepts that can be understood from each of the above embodiments and modified examples will now be described.
(1) An information processing device including a processor and a memory, in which the processor is configured to
   obtain an original text input by an administrator, obtain a guideline related to editing of the original text from the memory,
   transmit the original text and the guideline to one or multiple editing models to obtain one or multiple edited texts in which the original text is edited in accordance with the guideline, and
   transmit the original text, one of the edited texts, and the guideline to an evaluation model to perform an evaluation to determine whether the one of the edited texts has been edited in accordance with the guideline.
(2) The information processing device of clause (1), in which
   the guideline includes a selection rule for selecting content that should be retained in the edited texts from the original text and,
   the evaluation includes an evaluation on a selection result of the content in each of the edited texts.
(3) The information processing device of clause (2), in which
   the selection rule specifies content to be retained in the edited texts in the content included in the original text, and
   performing the evaluation includes excluding, when the original text does not include the content to be retained, an edited text generated from the original text from an evaluation target for the selection result.
(4) The information processing device of clause (2) or (3), in which
   the selection rule specifies content to be deleted from the original text,
   the evaluation includes an evaluation of a deletion result of the content, and
   performing the evaluation includes excluding, when the original text does not include the content to be deleted, an edited text generated from the original text from an evaluation target for the deletion result.
(5) The information processing device of any one of clauses (1) to (4), in which
   the guideline includes an ordering rule that specifies an arrangement order of sentences, and
   when the edited text included multiple sentences, the evaluation includes evaluation to determine whether the sentences in the edited text are arranged in accordance with the ordering rule.
(6) The information processing device of any one of clauses (1) to (5), in which
   the guideline includes a modification rule that specifies a modification method for modifying a textual expression in the original text, and
   the evaluation includes an evaluation to determine whether a textual expression in the edited text is in accordance with the modification rule.
(7) The information processing device of any one of clauses (1) to (6), in which the evaluation is performed based on an evaluation value obtained by calculating an evaluation result obtained from the evaluation model and an evaluation coefficient.
(8) The information processing device of clause (7), in which the evaluation is performed based on an evaluation value obtained by calculating an evaluation result obtained from the evaluation model and an evaluation coefficient based on an action history of a prospective transactor.
(9) The information processing device of any one of clauses (1) to (8), in which
   the multiple editing models include a first editing model and a second editing model,
   the multiple edited sentences include a first edited sentence obtained from the first editing model and a second edited sentence obtained from the second editing model,
   performing the evaluation includes
      transmitting the original text, the first edited sentence, and the guideline to the evaluation model to obtain a first evaluation of the first edited sentence,
      transmitting the original text, the second edited sentence, and the guideline to the evaluation model to obtain a second evaluation of the second edited sentence, and
      performing evaluation to determine which of the first edited sentence and the second edited sentence is more appropriate by comparing the first evaluation and the second evaluation.
(10) The information processing device of any one of clauses (1) to (9), in which at least one of the one or multiple servers is configured to modify the guideline based on a result of the evaluation.
(11) An information processing system including one or multiple servers, in which
   at least one of the one or multiple servers is configured to obtain an original text input by an administrator,
   at least one of the one or multiple servers is configured to obtain a guideline related to editing of the original text from a memory,
   at least one of the one or multiple servers is configured to transmit the original text and the guideline to one or multiple editing models to obtain one or multiple edited texts in which the original text is edited in accordance with the guideline, and
   at least one of the one or multiple servers is configured to transmit the original text, one of the edited texts, and the guideline to an evaluation model to perform an evaluation to determine whether the one of the edited texts has been edited in accordance with the guideline.
(12) An information processing method causes one or multiple computers to
   obtain an original text input by an administrator,
   obtain a guideline related to editing of the original text from a memory,
   transmit the original text and the guideline to an editing model to obtain an edited text in which the original text is edited in accordance with the guideline, and
   evaluate the edited text by transmitting the original text, the guideline, and the edited text to an evaluation model.
(13) A non-transitory computer readable medium storing a program for causing one or multiple computers to
   obtain an original text input by an administrator,
   obtain a guideline related to editing of the original text from a memory,
   transmit the original text and the guideline to one or multiple editing models to obtain one or multiple edited texts in which the original text is edited in accordance with the guideline, and
   transmit the original text, one of the edited texts, and the guideline to an evaluation model to perform an evaluation to determine whether the one of the edited texts has been edited in accordance with the guideline.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An information processing system, comprising one or multiple servers, wherein
at least one of the one or multiple servers is configured to obtain an original text input by an administrator,
at least one of the one or multiple servers is configured to obtain a guideline related to editing of the original text from a memory,
at least one of the one or multiple servers is configured to transmit the original text and the guideline to one or multiple editing models to obtain one or multiple edited texts in which the original text is edited in accordance with the guideline, and
at least one of the one or multiple servers is configured to transmit the original text, one of the edited texts, and the guideline to an evaluation model to perform an evaluation to determine whether the one of the edited texts has been edited in accordance with the guideline.

2. The information processing system according to claim 1, wherein
the guideline includes a selection rule for selecting content that should be retained in the edited texts from the original text and,
the evaluation includes an evaluation on a selection result of the content in each of the edited texts.

3. The information processing system according to claim 2, wherein
the selection rule specifies content to be retained in the edited texts in the content included in the original text, and
performing the evaluation includes excluding, when the original text does not include the content to be retained, an edited text generated from the original text from an evaluation target for the selection result.

4. The information processing system according to claim 2, wherein
the selection rule specifies content to be deleted from the original text,
the evaluation includes an evaluation of a deletion result of the content, and
performing the evaluation includes excluding, when the original text does not include the content to be deleted, an edited text generated from the original text from an evaluation target for the deletion result.

5. The information processing system according to claim 1, wherein
the guideline includes an ordering rule that specifies an arrangement order of sentences, and
when the edited text included multiple sentences, the evaluation includes evaluation to determine whether the sentences in the edited text are arranged in accordance with the ordering rule.

6. The information processing system according to claim 1, wherein
the guideline includes a modification rule that specifies a modification method for modifying a textual expression in the original text, and
the evaluation includes an evaluation to determine whether a textual expression in the edited text is in accordance with the modification rule.

7. The information processing system according to claim 1, wherein the evaluation is performed based on an evaluation value obtained by calculating an evaluation result obtained from the evaluation model and an evaluation coefficient.

8. The information processing system according to claim 7, wherein the evaluation is performed based on an evaluation value obtained by calculating an evaluation result obtained from the evaluation model and an evaluation coefficient based on an action history of a prospective transactor.

9. The information processing system according to claim 1, wherein
the multiple editing models include a first editing model and a second editing model,
the multiple edited sentences include a first edited sentence obtained from the first editing model and a second edited sentence obtained from the second editing model, performing the evaluation includes:
transmitting the original text, the first edited sentence, and the guideline to the evaluation model to obtain a first evaluation of the first edited sentence;
transmitting the original text, the second edited sentence, and the guideline to the evaluation model to obtain a second evaluation of the second edited sentence; and
performing evaluation to determine which of the first edited sentence and the second edited sentence is more appropriate by comparing the first evaluation and the second evaluation.

10. The information processing system according to claim 1, wherein at least one of the one or multiple servers is configured to modify the guideline based on a result of the evaluation.

11. An information processing method, comprising causing one or multiple computers to:
obtain an original text input by an administrator,
obtain a guideline related to editing of the original text from a memory;
transmit the original text and the guideline to one or multiple editing models to obtain one or multiple edited texts in which the original text is edited in accordance with the guideline, and
transmit the original text, one of the edited texts, and the guideline to an evaluation model to perform an evaluation to determine whether the one of the edited texts has been edited in accordance with the guideline.

12. A non-transitory computer readable medium storing a program for causing one or multiple computers to:
obtain an original text input by an administrator,
obtain a guideline related to editing of the original text from a memory;
transmit the original text and the guideline to one or multiple editing models to obtain one or multiple edited texts in which the original text is edited in accordance with the guideline, and
transmit the original text, one of the edited texts, and the guideline to an evaluation model to perform an evaluation to determine whether the one of the edited texts has been edited in accordance with the guideline.
